(19) United States
(12) Patent Application Publication
(10) Pub. No.: US 2008/0077759 A1
(43) Pub. Date: Mar. 27, 2008

(54) MEMORY CONTROL APPARATUS AND METHOD FOR ALLOCATING ACCESS RIGHTS

(75) Inventors: MICHAEL GOEDECKE, Starnberg (DE); DAVID ADDISON, Bristol (GB); RICHARD KNIGHT, Baierbrunn (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Neubiberg (DE)

(21) Appl. No.: 11/853,161

(22) Filed: Sep. 11, 2007

(30) Foreign Application Priority Data
Sep. 27, 2006 (DE) 10 2006 045 655.6

(51) Int. Cl. G06F 12/00

(52) U.S. Cl. 711/163

(57) ABSTRACT

A memory control apparatus in which, in the case of a sequence of requests for a sequence of accesses from an access unit to result in execution of an operation in the memory, the access unit is granted right to use the memory control apparatus to carry out the sequence of accesses and every other access unit is denied right to use the memory control apparatus to access the memory until all of the accesses in the sequence of accesses have been carried out.

### CROSS-REFERENCE TO RELATED APPLICATION

This application claims priority to German Patent Application Serial No. 10 2006 045 655.6, which was filed Sep. 27, 2006, and is incorporated herein by reference in its entirety.

### TECHNICAL FIELD

The invention relates to a memory control apparatus and to a method for allocating access rights.

### BACKGROUND OF THE INVENTION

In some flash memories, a write operation includes a sequence of a plurality of write commands and read commands on the memory bus. That is to say, in order to write data to such a flash memory, it is necessary to access the flash memory several times. Methods which carry out such write operations efficiently and correctly are desirable.

### BRIEF DESCRIPTION OF THE FIGURES

Exemplary embodiments of the invention are illustrated in the figures and are explained in more detail below.

FIG. 1 shows a data processing system according to one exemplary embodiment of the invention.

FIG. 2 shows a memory control unit according to one exemplary embodiment of the invention.

FIG. 3 shows a flowchart according to one exemplary embodiment of the invention.

### DETAILED DESCRIPTION OF THE INVENTION

NOR flash memories are addressed using an address and data bus interface. They allow random access to the stored data only in the case of a read access. In the case of write access, it must be taken into account that the bytes are grouped to form blocks. The individual bytes can be written independently of one another. However, the bits can only change from 1 to 0. An erase operation which can always only be applied to a complete block is needed to set bits to 1. The erasure of bits, the writing of bits and other operations are controlled using commands. A command comprises one or more write cycles or read cycles on the memory bus. These are interpreted by the command interface of the NOR flash memory.

A write operation includes a sequence of a plurality of write commands and read commands on the memory bus. That is to say, in order to write data to such a flash memory, it is necessary to access the flash memory several times. For example, it may be necessary to write a predefined value to a memory location of the flash memory, to which data are intended to be written, before the data are written or to read the contents of a status register of the flash memory after the data have been written to a memory location in the flash memory in order to be able to check whether the data have been written successfully.

Since a write access to such a flash memory includes a sequence of accesses to the flash memory, it is necessary for the unit which is carrying out the write access to the flash memory to have exclusive access to the flash memory for the period in which the sequence of accesses to the flash memory is being executed. That is to say, if a further unit were to access the flash memory during the sequence, the operation of writing the data could fail, for example since the unit performing the write operation cannot execute the sequence in full.

This occurs not only in flash memories but in all types of memories in which a sequence of accesses to the memory is needed to execute an operation, for example to store data.

If only processors access such a memory, a mutex (mutual exclusion) method can be used to prevent a processor accessing the memory while another processor is currently executing a sequence for storing data in the memory. This procedure is a solution at the operating system level. It requires the operating system to provide methods for mutual exclusion (mutex), requires a software overhead and results in increased computation complexity.

Furthermore, this procedure cannot be readily used for the situation in which, apart from processors, DMA (Direct Memory Access) units also access the memory since an operating system typically has only meager options for controlling DMA units. In an extreme case, the DMA units used in a computer system are not visible to the operating system and the solution described above cannot be used.

One embodiment of the invention provides a possible way of using memories in which a plurality of accesses are needed to execute an operation, for example to store data.

One embodiment of the invention provides a memory control apparatus having a memory interface which can be coupled to a memory (or else to a plurality of memories in one exemplary embodiment), a plurality of access interfaces, each access interface being able to be coupled to at least one access unit, a receiving device which is set up to receive requests to access the memory (or one of the memories) from the access units, and a controller which is set up, if the receiving device receives a sequence of requests for a sequence of accesses from an access unit, said sequence of accesses resulting in the execution of an operation in the memory, to grant the access unit the right to use the memory control apparatus to carry out the sequence of accesses and to deny every other access unit the right to use the memory control apparatus to access the memory until all of the accesses in the sequence of accesses have been carried out.

Another embodiment of the invention provides a method for allocating access rights to access a memory, which is coupled to a memory control apparatus by means of a memory interface, to a plurality of access units which are coupled to the memory control apparatus by means of access interfaces, in which the memory control apparatus receives requests to access the memory from the access units, and in which, if the memory control apparatus receives a sequence of requests for a sequence of accesses from an access unit, said sequence of accesses resulting in the execution of an operation in the memory, the access unit is granted the right to use the memory control apparatus to carry out the sequence of accesses, and every other access unit is denied the right to use the memory control apparatus to access the memory until all of the accesses in the sequence of accesses have been carried out. Clearly, the controller grants the access unit the access right without interruption until the sequence has been processed and the operation in the memory, for example the storage of data, has thus been executed in full. The access unit is thus granted an exclusive access right to the memory while it is carrying out the sequence of accesses and all other access units are denied access. If requests are received from different access units (which are also referred to as masters of the memory) and if an exclusive access right is not currently allocated, the controller allocates the access right, for example, in accordance with prioritization of the access units, for instance simply in accordance with a round-robin method. Clearly, however, the controller changes the arbitration strategy if an access unit begins a sequence of accesses, which result in the execution of an operation in the memory, with an access for which it has been granted the right. In this case, it is also then granted the access right until it has carried out the sequence of accesses.

One exemplary embodiment of the invention makes it possible for a plurality of masters to securely access a memory, in which it is necessary to carry out a plurality of successive accesses (that is to say a programming sequence) in order to store data. Collisions and interruptions in a programming sequence and resultant errors are avoided at the hardware level, that is to say without it being necessary for the operating system to have knowledge of them or to provide routines for this purpose. The invention can also be used for the situation in which an access unit is a DMA (direct memory access) unit.

The described refinements of the invention which are described in connection with the memory control apparatus also apply analogously to the method for allocating access rights.

The execution of the operation in the memory is, for example, storage of data in the memory. The execution of the operation in the memory may also be, for example, programming of configuration registers in the memory, for example of a flash memory, a cellular RAM (Random Access Memory) memory or a mobile SDRAM (Synchronous Dynamic RAM) memory.

The sequence of accesses and accordingly the operation to be executed are, for example, configured in such a manner that, if the sequence of accesses is interrupted by access by another access unit, it is possible that the operation will not be executed correctly.

In one embodiment, the controller is set up to grant the access unit the right to use the memory control apparatus to carry out the sequence of accesses if, at the time of the first request in the sequence of requests, no other access unit has been granted the right to carry out a sequence of accesses to the memory which result in the execution of an operation in the memory.

In one embodiment, the controller is set up to grant the access unit the right to use the memory control apparatus to carry out the sequence of accesses if, at the time of the first request in the sequence of requests, there is no request to access the memory from another access unit which is assigned a higher access priority than the access unit.

For example, the controller is set up to deny every other access unit the right to use the memory control apparatus to access the memory if the access unit has been granted the right to a memory access and the access unit has not yet carried out a read access to the memory since the memory access.

Clearly, a write access is used to automatically detect that a sequence of accesses has been started and a read access is used to automatically detect that a programming sequence has been concluded. This is suitable for an embodiment in which a sequence of accesses has only one single read access, for instance for reading a status register, in order to determine whether the storage of data was successful.

In one embodiment, the beginning and end of the sequence of requests are explicitly defined. For example, the beginning and end of the sequence of requests are signaled to the memory control apparatus and/or the memory control apparatus is configured in a corresponding manner.

For example, the memory control apparatus has a further receiving device which is set up to receive a message from the access unit specifying that the sequence of accesses results in the execution of an operation in the memory.

The access unit thus explicitly signals, for example in the form of a separate signal or in the form of a special request identifier, after the first access in the sequence of accesses, that the sequence of accesses forms a unit in the sense that they result in the execution of an operation in the memory. For example, this indicates to the memory control apparatus that the sequence of accesses should not be interrupted by access by another access unit.

The memory control apparatus may also have a timer which is set up to measure the period of time for which the access unit is granted the right to use the memory control apparatus to carry out the sequence of accesses, the controller being set up to no longer deny every other access unit the right to use the memory control apparatus to access the memory if the period of time has exceeded a maximum period which can be set.

It is thus possible to avoid an access unit permanently blocking a memory, for instance because it has been reset during a programming sequence or does not conclude a sequence of accesses for another reason.

The memory control apparatus may have a further memory interface which can be coupled to a further memory.

The controller is set up, for example, to no longer deny every other access unit the right to use the memory control apparatus to access the memory as soon as the access unit has accessed the further memory.

Clearly, use is made of the information that the access unit must have concluded the sequence of accesses since it has already accessed the other memory.

In one embodiment, the controller is set up to grant another access unit, which has requested to access the further memory, the right to access the further memory while the access unit has been granted the right to use the memory control apparatus to carry out the sequence of accesses.

The other access unit can thus access the further memory, while access to the memory is denied to all access units except for the access unit which is carrying out the programming sequence. It is thus possible to access the memory and the further memory in a parallel manner in contrast to a bus system since, in the case of the latter, the bus is completely blocked during access.

The memory is, for example, a (burst) flash memory, a cellular RAM (Random Access Memory) memory, an SDRAM (Synchronous Dynamic RAM) memory or a DDR SDRAM (Double Data Rate SDRAM) memory.

However, the memory may also be understood as meaning only a chip in a memory module. In particular, it is also possible to simultaneously access a plurality of chips in a memory module, that is to say the exclusive access right can only be allocated for one chip in the memory module. In an analogous manner, an exclusive access right for a chip can be canceled if the respective access unit accesses another chip.

The access units are, for example, processors or DMA units.

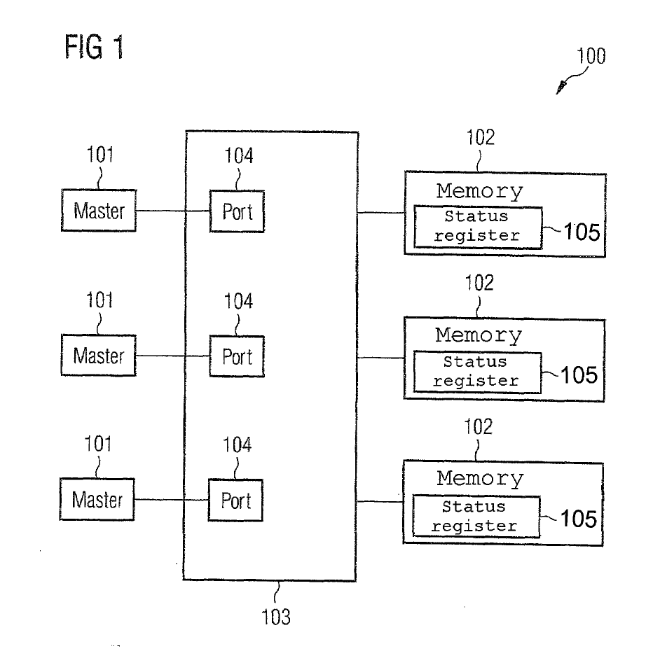

FIG. 1 shows a data processing system 100 according to one exemplary embodiment of the invention.

The data processing system 100 has a plurality of masters 101 and a plurality of memories 102. In this context, a master 101 is to be understood as meaning a unit which can write data to a memory 102 and can read data from a memory 102. The masters 101 access the memories 102 using a memory control unit (memory controller) 103. The masters 101 are, for example, processors or DMA units.

For example, the masters 101 and the memory control unit 103 are arranged in a portable electronic device, for example a mobile radio telephone, and the memories 102 are internal or external memories of the electronic device. In this case, one of the masters 101 is, for example, an ARM (Acorn Risc Machine) processor. The memories 102 are, for example, (burst) flash memories, cellular RAM (Random Access Memory) memories, SDRAM (Synchronous Dynamic RAM) memories or DDR SDRAM (Double Data SDRAM) memories.

The memory control unit 103 provides, for each of the masters 101, a port 104 by means of which the respective master 101 and the memory control unit 103 interchange data. For example, a master 101 uses the port 104 that has been provided for it to transmit the address of a memory cell of one of the memories 102, to which it would like to write data or from which it would like to read data, and, if appropriate, the data to be written and the information regarding which of the memories 102 the master 101 would like to write data to or which of the memories 102 the master 101 would like to read data from. For example, the memory control unit 103 uses the port 104 provided in the master 101 to transmit data, which are stored in a memory cell of a memory 102, from which the master 101 would like to read, to the master 101.

It is assumed that, in order for a master 101 to store data in a memory 102, a sequence of accesses to the memory 102 is required. For example, it is necessary, at the beginning of such an access sequence for storing data in a memory cell of a memory 102, to first of all write a predefined value to the memory cell.

In one exemplary embodiment of the invention, the memories 102 each have a status register 105 and, after each access sequence for storing data in a memory cell, provision is made for a value to be read from the respective status register 105, said value indicating whether the operation of writing the data to the memory cell was successful.

The structure of the memory control unit 103 is explained in more detail below.

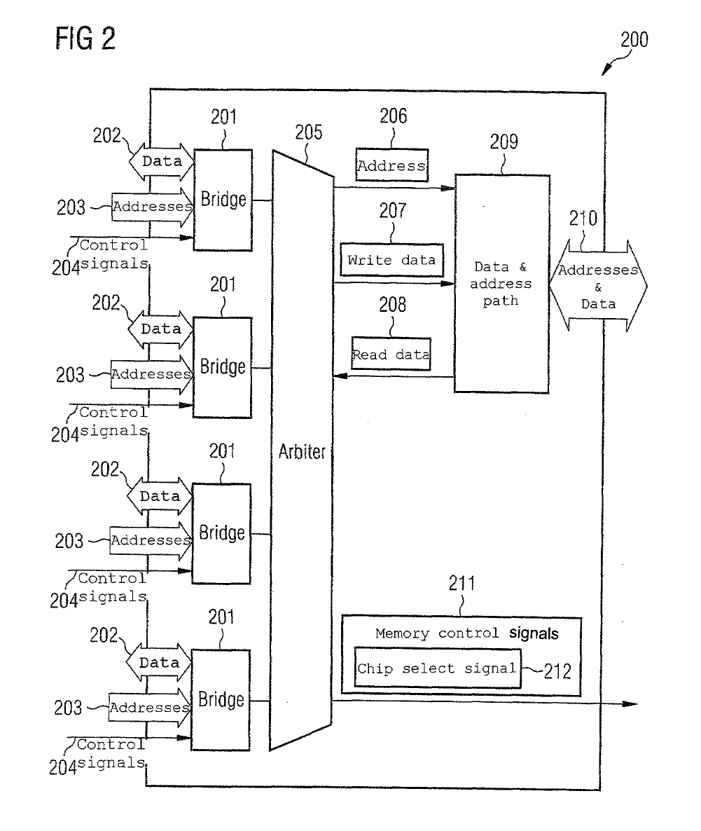

FIG. 2 shows a memory control unit 200 according to one exemplary embodiment of the invention.

The memory control unit 200 has a plurality of bridges 201, each of which implements a port 104 for communicating with a master 101, as explained with reference to FIG. 1. Each bridge 201 can receive data 202 which are to be written to a memory 102, can transmit data 202 which have been read from a memory 102 to a master 101, can receive addresses 203 of memory cells to which data are intended to be written or from which data are intended to be read, and can receive control signals 204 from one of the masters 101. The control signals 204 are, for example, an area selection signal which specifies that area of a memory 102 to which data are intended to be written or from which data are intended to be read, and a memory selection signal which indicates, if a plurality of memories 102 are coupled to the memory control unit 200, the memory 102 to which data are intended to be written or from which data are intended to be read. One of the control signals 204 may also be a read/write signal which the respective master 101 uses to specify whether data are intended to be written to a memory 102 or whether data are intended to be read from a memory 102.

For the sake of simplicity of the further explanation, it is now assumed that the memory control unit 200 is coupled to only one memory 102. In particular, it is assumed, if two masters 101 would like to access a memory 102, that the two masters 101 would like to access the same memory 102.

If two masters 101 would like to access the memory 102, the access right can be granted to only one master 101. The master 101 to which the access right is granted is governed by an arbiter 205 of the memory control unit 200. The type of arbitration carried out by the arbiter 205 is explained in more detail further below.

As mentioned above, in order for the master 101 to store data in a memory cell of the memory 102, a plurality of read accesses and write accesses to the memory 102 are required, for example a read access to the status register 105 of the memory 102, in order to be able to check whether the data have been stored correctly. The operation of storing data in the memory 102 (also referred to as a programming sequence) thus includes a sequence of a plurality of read accesses and/or write accesses to the memory 102. A read access or a write access thus means an individual read command or write command, for example the operation of reading a value from a particular memory cell of the memory 102, the operation of reading a value from the status register 105 of the memory 102, the operation of writing a value to a particular memory cell or else the operation of writing a value to the status register 105.

If the arbiter 205 has granted a master 101 the right to a read access or a write access, it transmits the address 206 of the memory cell (which can also be the address of a memory cell of the status register 105), to which data are intended to be written or from which data are intended to be read, and, if appropriate, the value 207 to be written to a data and address path 209 which transmits the address 206 and, if appropriate, the value 207 to be written to the memory 102, as indicated by the double-headed arrow 210.

If a read access is involved, the data and address path 209 receives the value 208 which has been read, as is likewise indicated by the double-headed arrow 210, and transmits the value 208 which has been read to the arbiter 205 which uses the corresponding bridge 201 to transmit the value 208 which has been read, in the form of the data 202, to the master 101 which has requested the read access.

The arbiter 205 also transmits memory control signals 211 to the memory 102, which control signals are needed to carry out the read access or the write access. For example, the memory control signals 211 may specify whether a read access or a write access is involved and that area of the memory 102 in which the memory cell specified by the address 206 is located. The areas of a memory 102 may be, for example, different chips of which the memory 102 is composed. In this case, the memory control signals 211 have a chip select signal 212 which specifies that chip in the memory 102 which is intended to be subjected to the read access or the write access. In one embodiment, the memory 102 has a separate status register 105 for each chip that it has.

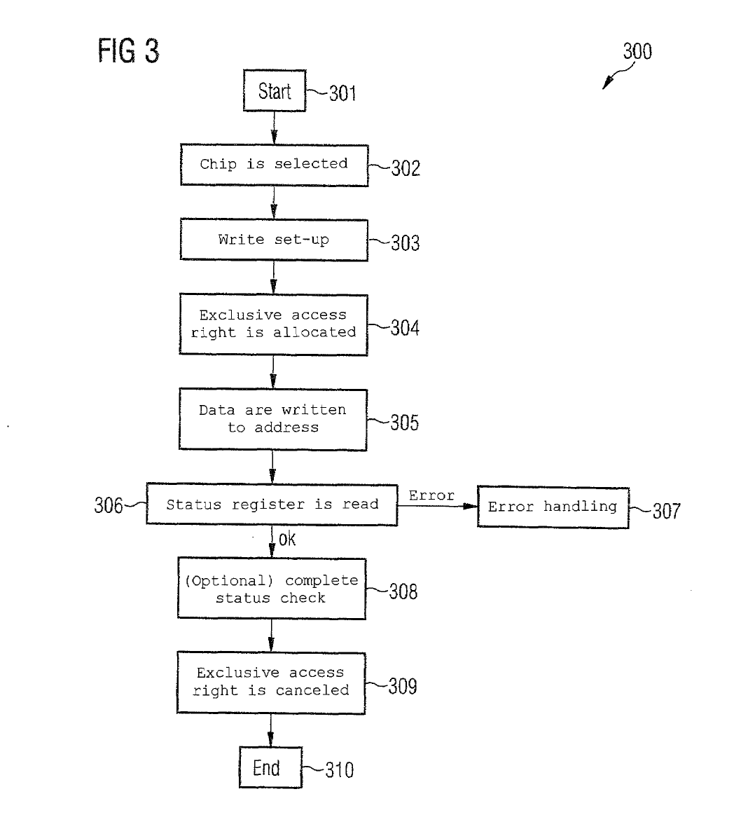

The execution of a sequence of accesses to the memory 102 for storing data in the memory 102 is explained below with reference to FIG. 3.

FIG. 3 shows a flowchart 300 according to one exemplary embodiment of the invention.

It is assumed that a master 101 would like to store data in the memory 102 (it is also assumed, for the sake of simplicity, that there is only one memory 102). In order to describe the invention in a more general manner, it is assumed that the memory 102 has a plurality of memory areas (chips in this case) and that the memory 102 has a status register 105 for each chip.

The sequence starts in step 301. The chip of the memory 102 containing the memory cell to which the data to be written are intended to be written is selected in step 302. The master 101 uses the control signals 204 to transmit an indication of this chip to the memory control unit 200. The arbiter 205 transmits the chip select signal 212 to the memory 102 in accordance with this information.

A write set-up is carried out in step 303. In this exemplary embodiment, the write set-up involves writing a predefined value to the memory cell to which the data to be written are intended to be written. This is the value 0x41 or the value 0x44, for example.

A write access to the memory cell to which the data to be written are intended to be written is thus first of all carried out. The master 101 transmits the address of the memory cell of the selected chip to the memory control unit 200 in the form of one of the addresses 203 and the arbiter 205 uses the data and address path 209 to transmit this address, as the address 206, to the memory 102, as explained with reference to FIG. 2. The arbiter 205 uses the data and address path 209 to transmit the predefined value, as the value 207 to be written, to the memory 102.

The write set-up may also involve writing a value of the status register 105 of the selected chip, that is to say of the chip containing the memory cell in which the data to be written are intended to be stored.

In step 304, the arbiter 205 sets an exclusive access right for the master (ownership lock). That is to say only the master 101 is allowed to access the selected chip of the memory 102.

As long as the exclusive access right is set, the arbiter 205 thus does not allow any of the other masters 101 the right to a read access or a write access to the selected chip.

In step 303, it was assumed that the master 101 which would like to store the data to be stored in the memory 102 is granted the write access right which is required for the write set-up. This is the case if there is no exclusive access right for one of the other masters 101 for the selected chip and if, at the time of the request from the master 101 to carry out the write access, no other master 101 having a higher priority than the master 101 would like to access the selected chip.

Clearly, a master 101 is thus granted an exclusive access right for a chip as soon as the master 101 has once been granted the right for a write access to the chip, which is the beginning of a sequence of accesses to the chip resulting in data being stored in the chip. The arbiter 205 denies all write accesses and read accesses of other masters 101 to the chip for the duration of the exclusive access right. However, the arbiter 205 enables read accesses and write accesses of other masters 101 to chips other than the selected chip (in particular to other memories 102 in the case of a plurality of memories) (provided that no other collisions occur in the process).

A sublogic unit, for example, of the arbiter 205 sets the exclusive access right to the selected chip for the master 101. For example, a flag of the arbiter 205 can be set in order to set the exclusive access right.

If a plurality of masters 101 simultaneously carry out programming sequences in different chips of the memory 102, a respective exclusive access right for the respective chip can be set for the masters 101.

In step 305, the master 101 uses a write access to store the data to be written in the memory cell. This write access forms a further access in the sequence of accesses to the memory 102 for the purpose of storing the data to be stored in the memory 102.

In step 306, a read access to the status register 105 of the selected chip is carried out as a further access in the sequence of accesses.

In this exemplary embodiment, a flag of the status register 105 is read, said flag indicating whether the operation of writing to the memory cell has been successfully concluded, for example whether the value to be written has already been accepted by the memory cell or must still be applied for further clock cycles. If the flag which has been read indicates that the operation of writing to the memory cell was not successful, error handling is carried out in step 307, said error handling only involving, for example, applying the value to be written to the memory cell for further clock cycles and then continuing with step 306 again. If the flag which has been read indicates that the operation of writing to the memory cell was successful, a complete status check of the status register 105 of the selected chip can be carried out, for example, in step 308 and further read accesses to the status register 105 of the selected chip can be used, for example, to read further flags. If errors are discovered in the process, error handling can be carried out again. If no errors are discovered during the complete status check, the operation of writing to the memory cell was successful and the sequence of accesses to the memory 102 is concluded.

The exclusive access right of the master 101 to the selected chip is canceled in step 309 and the sequence ends in step 310.

The exclusive access right of a master 101 to a chip is thus canceled if the last access in the sequence of accesses for writing data to the chip has been carried out successfully. If the sequence of accesses has only one single read access at the end of the sequence (which is the case in the example above if the complete status check is not carried out), the read access can be used to automatically determine that the programming sequence has been concluded. The exclusive access right can thus be automatically canceled in this case if a read access occurs.

In an analogous manner, if a programming sequence always begins with a write access, an exclusive access right to a chip can be automatically granted to a master 101 as soon as the master 101 has carried out a write access to the chip. Provision may also be made of a timer which begins to run if a write access has been carried out by a master 101 and an exclusive access right to the selected chip has been accordingly granted to this master 101. The master 101 is deprived of the exclusive access right after a period of time which can be set in the arbiter 205, for example, has elapsed. This makes it possible to avoid the situation in which a programming sequence is not concluded correctly, the corresponding master 101 is thus not deprived of the exclusive access right and the master 101 unnecessarily retains the exclusive access right and accesses to the selected chip by other masters 101 are correspondingly prevented.

A master 101 can also be automatically deprived of an exclusive access right to a chip if the master 101 carries out a write access to another chip since it can be assumed in this case that a programming sequence for storing data in the chip has been concluded.

In one embodiment, the memory control unit 200 is coupled to a plurality of memories 102 and a separate data and address path 209 is provided for each memory 102. For example, a plurality of masters 101 may simultaneously access different memories 102. Parallel access is thus clearly possible.

The memory control unit 200 is arranged between the masters 101 and the memories 102. The masters 101 thus access the memories 102 using the memory control unit which can be considered to be an interface between the masters 101 and the memories 102.

The architecture described differs from a bus system. The masters 101, for example, thus use a central unit, the memory control apparatus 103, to access the memories 102 and the memory control apparatus grants or does not grant the access right, that is to say forwards or does not forward access commands to the memories, depending on the allocation of rights.

In summary, one exemplary embodiment of the invention describes a memory control apparatus having
a memory interface which is coupled to a memory, the memory having at least one memory chip, for example;
a plurality of access interfaces, each access interface being coupled to at least one access unit;
a receiving device which receives requests to access the memory from the access units;
a controller which, if the receiving device receives a sequence of requests for a sequence of accesses from an access unit, said sequence of accesses resulting in data being stored in the memory, grants the access unit the right to use the memory control apparatus to carry out the sequence of accesses and denies every other access unit the right to use the memory control apparatus to access the memory until all of the accesses in the sequence of accesses have been carried out.

What is claimed is:

1. A memory control apparatus, comprising:
a memory interface which can be coupled to a memory;
a plurality of access interfaces, each access interface able to be coupled to at least one access unit;
a receiving device configured to receive requests to access the memory from the access units; and
a controller configured, if the receiving device receives a sequence of requests for a sequence of accesses from an access unit for resulting in execution of an operation in the memory, to grant the access unit right to use the memory control apparatus to carry out the sequence of accesses and to deny every other access unit right to use the memory control apparatus to access the memory until all of the accesses in the sequence of accesses have been carried out.

2. The memory control apparatus as claimed in claim 1, wherein the execution of the operation in the memory is storage of data in the memory.

3. The memory control apparatus as claimed in claim 1, wherein the controller is configured to grant the access unit the right to use the memory control apparatus to carry out the sequence of accesses if, at the time of the first request in the sequence of requests, no other access unit has been granted the right to carry out a sequence of accesses to the memory which results in the execution of an operation in the memory.

4. The memory control apparatus as claimed in claim 1, wherein the controller is configured to grant the access unit the right to use the memory control apparatus to carry out the sequence of accesses if, at the time of the first request in the sequence of requests, there is no request to access the memory from another access unit which is assigned a higher access priority than the access unit.

5. The memory control apparatus as claimed in claim 1, wherein the controller is configured to deny every other access unit the right to use the memory control apparatus to access the memory if the access unit has been granted the right to a memory access and the access unit has not yet carried out a read access to the memory since the memory access.

6. The memory control apparatus as claimed in claim 1, further comprising a further receiving device configured to receive a message from the access unit specifying that the sequence of accesses results in the execution of an operation in the memory.

7. The memory control apparatus as claimed in claim 1, further comprising a timer configured to measure a period of time for which the access unit is granted the right to use the memory control apparatus to carry out the sequence of accesses, and the controller configured to no longer deny every other access unit the right to use the memory control apparatus to access the memory if the period of time has exceeded a predetermined period of time.

8. The memory control apparatus as claimed in claim 1, further comprising a further memory interface which can be coupled to a further memory.

9. The memory control apparatus as claimed in claim 8, wherein the controller is configured to no longer deny every other access unit the right to use the memory control apparatus to access the memory as soon as the access unit has accessed the further memory.

10. The memory control apparatus as claimed in claim 8, wherein the controller is configured to grant another access unit, which has requested to access the further memory, the right to access the further memory while the access unit has been granted the right to use the memory control apparatus to carry out the sequence of accesses.

11. The memory control apparatus as claimed in claim 1, wherein the memory is a memory selected from the group consisting of: a flash memory, a burst flash memory, a cellular RAM memory, an SDRAM memory, and a DDR SDRAM memory.

12. The memory control apparatus as claimed in claim 1, wherein at least one of the access units is a processor.

13. The memory control apparatus as claimed in claim 1, wherein at least one of the access units is a Direct Memory Access unit.

14. A method for allocating access rights to access a memory, which is coupled to a memory control apparatus via a memory interface, to a plurality of access units which are coupled to the memory control apparatus via access interfaces, the method comprising:
using the memory control apparatus to receive requests from the access units to access the memory;
granting, if the memory control apparatus receives a sequence of requests for a sequence of accesses from an access unit for resulting in the execution of an operation in the memory, the access unit right to use the memory control apparatus to carry out the sequence of accesses; and
denying every other access unit right to use the memory control apparatus to access the memory until all of the accesses in the sequence of accesses have been carried out.

15. A memory control apparatus comprising:
a memory interface which can be coupled to a memory;
a plurality of access interfaces, each access interface being able to be coupled to at least one access unit;
a receiving device configured to receive requests to access the memory from the access units; and
a controller configured, if the receiving device receives a sequence of requests for a sequence of accesses from an access unit for resulting in execution of an operation in the memory, to grant the access unit right to use the memory control apparatus to carry out the sequence of accesses and to deny every other access unit right to use the memory control apparatus to access the memory until the access unit has carried out a read access to the memory.

16. A memory control apparatus, comprising:
a memory interface which can be coupled to a memory;
a plurality of access interfaces, each access interface able to be coupled to at least one access unit;
a receiving device configured to receive requests to access the memory from the access units; and
a controlling means for, if the receiving device receives a sequence of requests for a sequence of accesses from an access unit for resulting in execution of an operation in the memory, granting the access unit right to use the memory control apparatus to carry out the sequence of accesses and denying every other access unit right to use the memory control apparatus to access the memory until all of the accesses in the sequence of accesses have been carried out.
